(19) United States
(12) Patent Application Publication
(10) Pub. No.: US 2011/0113367 A1
(43) Pub. Date: May 12, 2011

(54) APPARATUS AND METHOD FOR PROVIDING OPTIONS TO CUSTOMIZE SETTINGS FOR USER MESSAGING

(75) Inventors: Lisa Louise Carter, Durham, NC (US); Neal Robert Caliendo, JR., Raleigh, NC (US); Holly Anne Edge, Raleigh, NC (US); Timothy Humphrey, Raleigh, NC (US); Paul Plaskonos, Raleigh, NC (US); Matthew Roper, Cary, NC (US)

(73) Assignee: Lenovo (Singapore) Pte. Ltd.

(21) Appl. No.: 12/613,997

(22) Filed: Nov. 6, 2009

(51) Int. Cl. G06F 3/048

(52) U.S. Cl. 715/808

(57) ABSTRACT

A method for displaying various types of messages received from a network to which an information handling system, such as a computer, is connected. A selection is made from a list of application programs installed on the system as to whether or not messages are displayed when selected ones of the application programs are running on the system. A message display system can be operated by preventing display of messages when the display of the system is in a particular mode, such as one of full screen mode or presentation mode. A selection may be made as to which types of messages are to be displayed. Only those types of messages that are selected are displayed on a display of the system. A medium can have code thereon for causing a system to implement the method. An information handling system, such as a computer, can have a processor and memory for storing instructions to implement the method.

### BACKGROUND

Subject matter presented herein relates generally to information handling systems, such as for example, computers, and more specifically to receiving alert messages on such systems or computers. More particularly, it relates to apparatus and methods for controlling the display of messages.

Numerous applications communicate messages to the user of an information handling system, and in particular to a personal computer, via “toast” notifications. These are small windows that popup in the corner of the desktop.

These popup alerts can also be distracting or annoying if the user is engaged in a sensitive task and does not want to be annoyed (e.g., while the user is showing a PowerPoint® presentation, watching a movie, etc.). While there is no way to guarantee never to annoy the user, it would be desirable if steps could be taken to greatly reduce the probability of such distractions.

### SUMMARY

An example of an application that communicate messages to the user of a computer is Message Center Plus, which is a Lenovo application that downloads messages from a server and displays them in popup notifications. A first generation of Message Center Plus is a utility/status monitor that informs a user, via a server, of system specific information and available upgrades/battery recalls, etc. Message Center Plus can also be used as an advertising medium; for example, it can be used to detect and tell users that they are backing up to a local storage and that it would be more advantageous to back up to an external hard disk device, which could be provided for a price.

Potentially, this type of system can generate customer complaints. Programs such as Ad-Aware® may detect Message Center as adware or as a trojan of sorts. Microsoft's Defender program could do the same thing and held Message Center as not a top level, but a second level threat.

The above problems may be addressed in accordance with the solutions set forth herein. There are two types of configuration options that will allow user to determine the tolerance level of messaging. One level is a basic configuration option that allows the user to select a category of messages to be displayed. Another level is an advanced configuration option, which allows the user to disable messaging based on applications running and/or the presentation mode enabled. Advanced configuration also manages messaging by time of day (Monday-Sunday; 12:00 am-11:59 pm), and whether the user wants to view messages manually or have the automatically “pop up”.

Thus, popup messages may be displayed based on a user's choice, and on whether an application is running. The user is presented with a set of applications (as represented, for example, from the install programs database). In a privacy settings context, the user is asked to select which applications should not receive popups (for which applications popups are not allowed while those applications are running), or to not receive popups when the application in running in a certain mode (such as during full screen display. The popups only pop up if the applications are not running. The privacy settings options are selected as part of an options menu. Alternatively, the user can elect to receive such popups when a particular application is running, or for example, if one or more of the Control Panel, the Event Viewer, or the Device Manager is being used.

The user can choose not to be bothered while an application is not running or while the user is not running certain other applications. The popup can be in the form of a balloon, a window or any other suitable form.

### BRIEF DESCRIPTION OF THE DRAWINGS

The foregoing aspects and other features of the present invention are explained in the following description, taken in connection with the accompanying drawings, wherein:

FIG. 1 is a block diagram of a computer system on which the embodiment described below may be used.

FIG. 2 is a flow chart of the operation of a preferred embodiment on the computer of FIG. 1.

FIG. 2A is a continuation of the of the flow chart of FIG. 2.

FIG. 3 is a screen present at a step of the flow chart of FIG. 2.

FIG. 4 is a screen present at a step of the flow chart of FIG. 2A.

### DETAILED DESCRIPTION OF THE PREFERRED EMBODIMENTS

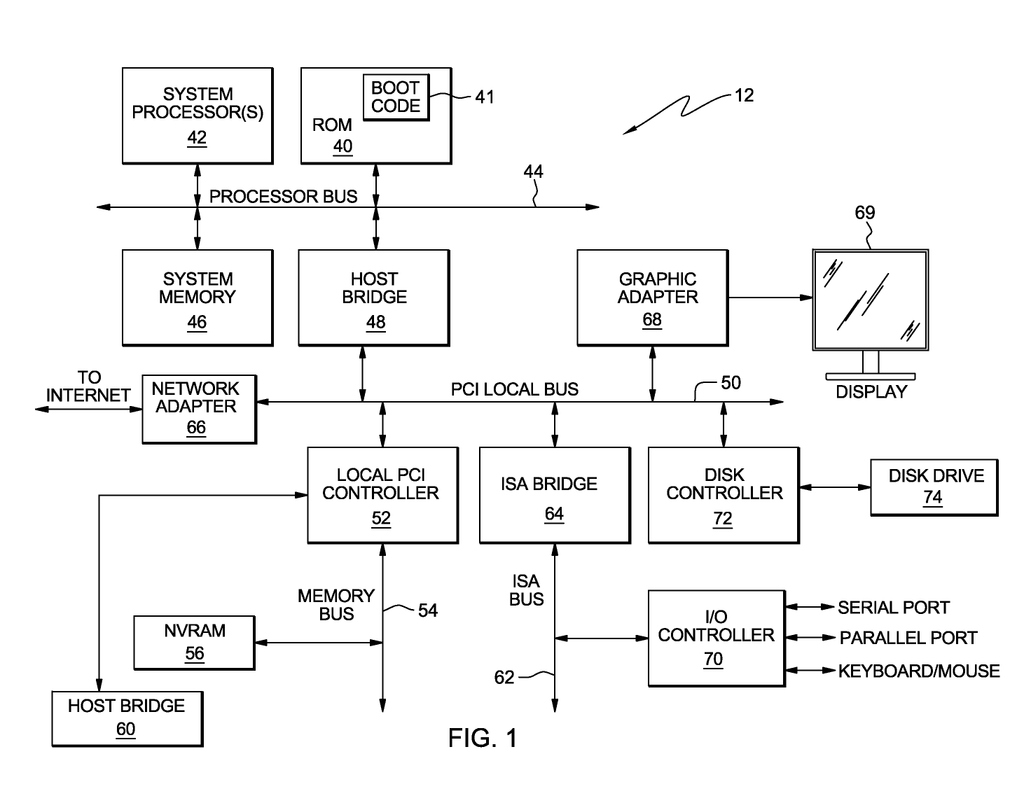

Referring now to FIG. 1, there is depicted a block diagram of an illustrative embodiment of a computer system 12. The illustrative embodiment depicted in FIG. 1 may be a desktop computer system, such as one of the ThinkCentre® or ThinkPad® series of personal computers sold by Lenovo (US) Inc. of Purchase, N.Y., or a workstation computer, such as the Intellistation®, which are sold by International Business Machines (IBM) Corporation of Armonk, N.Y.; however, as will become apparent from the following description, the embodiments are applicable to any data processing system or information handling system. As used herein, the term information handling system includes, but is not limited to a cell phone, a personal digital assistance, a Blackbury® device, a wrist watch computer, the types of computers mentioned above, as well as any other types of computers, and other devices having a digital data processor and a memory.

As shown in FIG. 1, computer system 12 includes at least one system processor 42, which is coupled to a Read-Only Memory (ROM) 40 and a system memory 46 by a processor bus 44. System processor 42, which may comprise one of the PowerPC™ line of processors produced by IBM Corporation, is a general-purpose processor that executes boot code 41 stored within ROM 40 at power-on and thereafter processes data under the control of operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 12 to LAN 10, and graphics adapter 68, which interfaces computer system 12 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 12 further includes Industry Standard Architecture (ISA) bus 62, which is coupled to PCI local bus 50 by ISA bridge 64. Coupled to ISA bus 62 is an input/output (I/O) controller 70, which controls communication between computer system 12 and attached peripheral devices such as a keyboard, mouse, and a disk drive, such as a CD drive. In addition, I/O controller 70 supports external communication by computer system 12 via serial and parallel ports. A disk controller 72 controls a disk drive 74, which may be a conventional hard drive.

Although the present embodiment will be described with reference to the computer described above, it should be understood that it can be implemented on many alternate types of computers.

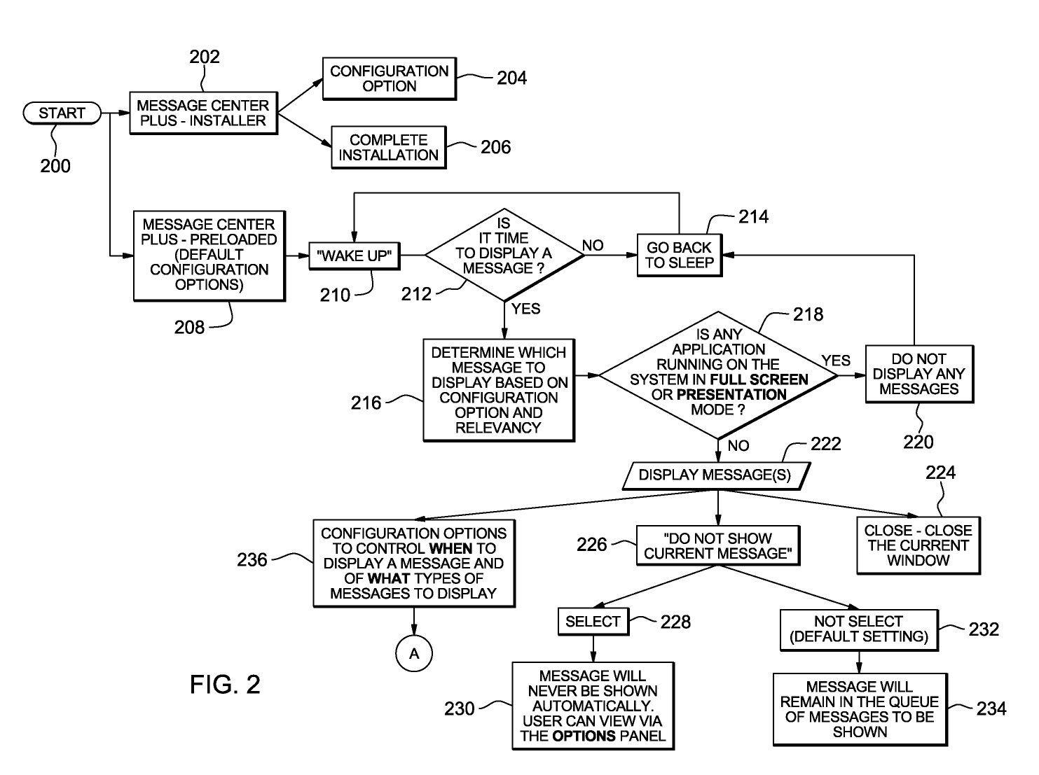

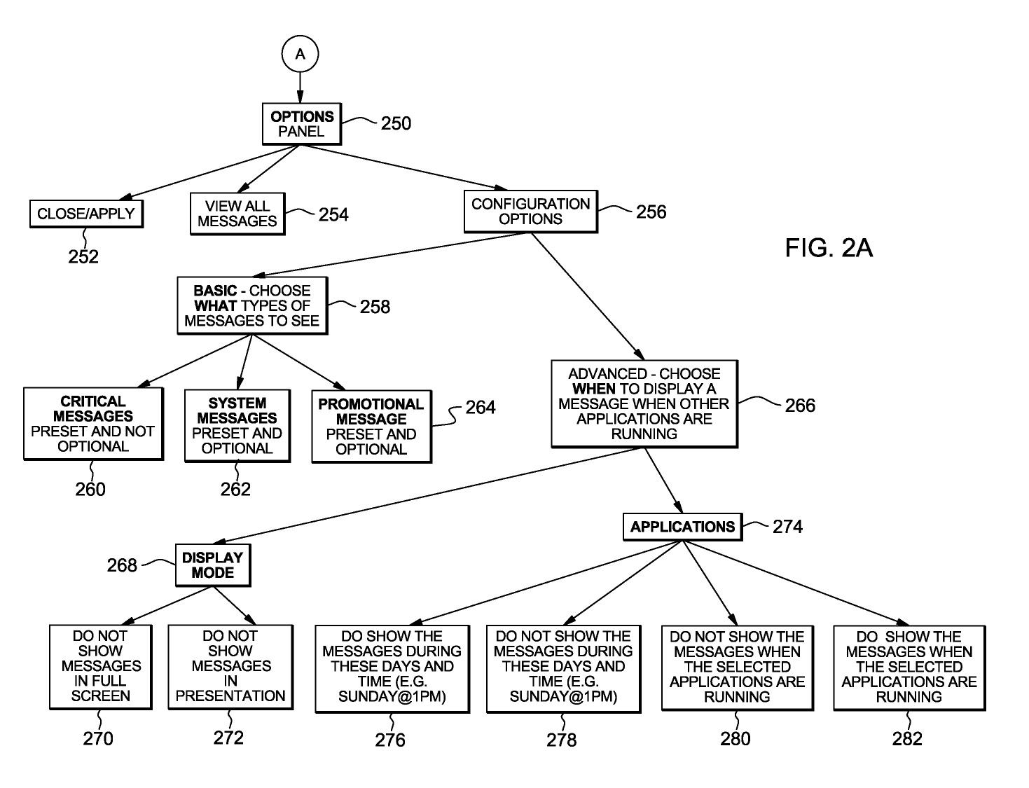

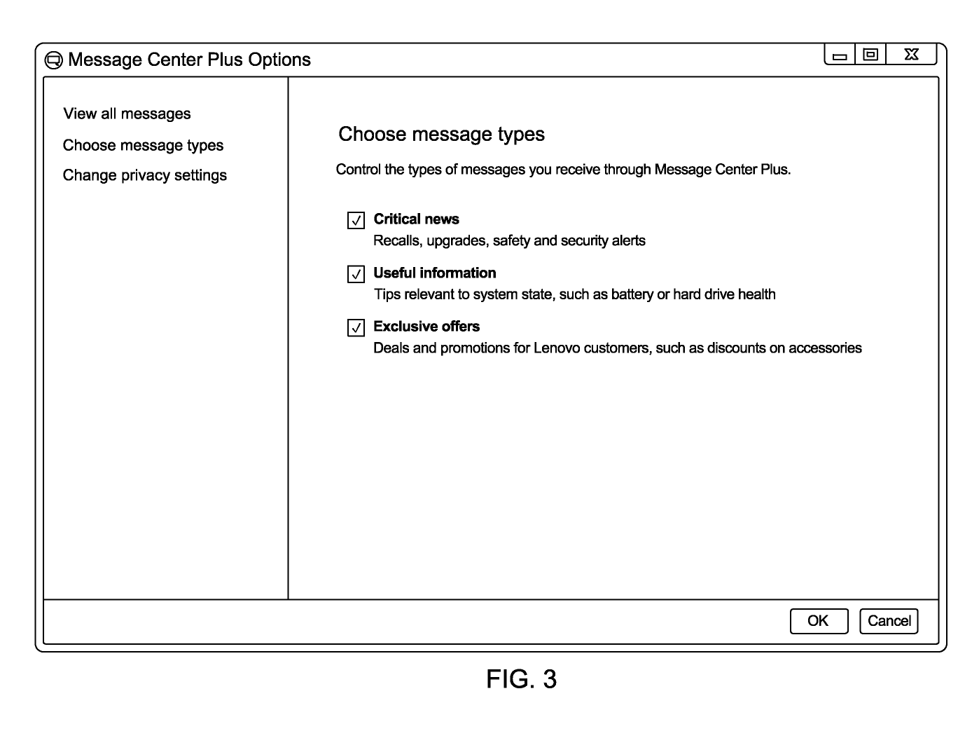

Referring to FIG. 2, the installation of a computer program to implement the embodiment illustrated herein is started at 200 by providing a storage medium having computer readable code thereon, which code can be transferred to memory of the computer of FIG. 1 (hard drive) by being placed in an appropriate disk drive associated with the computer, or by downloading from a network or the internet via network adapter 66 (FIG. 1). During Installation, an installer Wizard is provided at step 202. The Wizard is configured with a first check box which causes a screen to appear that allows review of options to be selected, or to complete the installation with review of options. If the box is checked, step 204 is next, where a configuration option window is provided (FIG. 3).

In the window of FIG. 3, the general types of messages that will be displayed are selected. These options include check boxes for critical news (recalls, upgrades, safety and security alerts), useful information (i.e. system messages, such as tips relevant to system state such as battery or hard drive health, etc.) and promotional messages (i.e. exclusive offers, including deals and promotions for company customers, such as discounts on accessories). At step 206, installation is completed, whether step 204 was skipped by not selecting the first check box, or step 204 was performed.

It is noted that when selections are made so as not to display certain types of messages, such as, for example, promotional messages, programs such as Ad-Aware® may be prevented from detecting those messages as adware or as a trojan of sorts, because a determination to avoid displaying those messages means that such programs never reach the stage of evaluating them as possible risks or unwanted distractions.

An alternative approach is to preload the software into the memory of computer system 12, as represented at step 208. Whether the software needs to be installed as described above, or whether it is preloaded, at step 210, (which may be, for example, on boot up of computer system 12, or at other times), the software “wakes up” (begins operation), and at step 212, a check is made as to whether any messages have been received from a network to which network adapter 66 (FIG. 1) is connected. If no messages have been received, the program goes back to sleep at 214. If messages have been received, at 216, a determination is made as to which messages to display based on selected or default configuration options, and relevancy. At step 218, a determination is made as to whether any application is running on computer system 12 in full screen or presentation mode. If the answer is yes, then at step 220, a determination is made to display no messages, and the software goes back to sleep, at step 214, at least until no application is in full screen or presentation mode. If there are no applications in full screen or presentation mode, at 222, the messages are displayed on the display 69 of computer system 12 in the form of a balloon, a window or any other suitable form

At step 224, the user has the option of closing the current message windows. At step 226, the user has the option of determining how to handle displayed messages. If step 228 is selected, then such messages will never be shown automatically. Instead, the user can view the message via an options panel. By not making a selection at step 232, the message will remain in the queue of messages to be shown, at 234.

The user may elect, at 236, to select a configuration option to control when and what types of messages are to be displayed.

Referring to FIG. 2A, at 250, an options panel is presented. At 252, selections made, as described below, may be applied, and the options panel may then be closed. At 254, all received messages may be viewed. At 256, a configuration option may be chosen. At 258, the basic configuration, as described above with respect to FIG. 3, of critical messages 260, system messages 262 and promotional messages 264 may each be selected or deselected.

At 266, an advanced configuration option is selected so that the user can choose when to display a message when other applications are running. At 268, display modes are selected. These may be do not show message when the display is in full screen mode at 270 or do not show message when in presentation mode at 272. At 276, a selection screen may be provided, and a selection may be made to show messages on certain days or dates, and time(s). At 278, a selection screen may be provided, and a selection may be made to not show messages on certain days or dates, and time(s). As used herein the word day may include day of the week or a particular date or dates. At 280, a selection is made to not show messages when a selected application is running. At 282 a selection is made to show messages when a selected application is running.

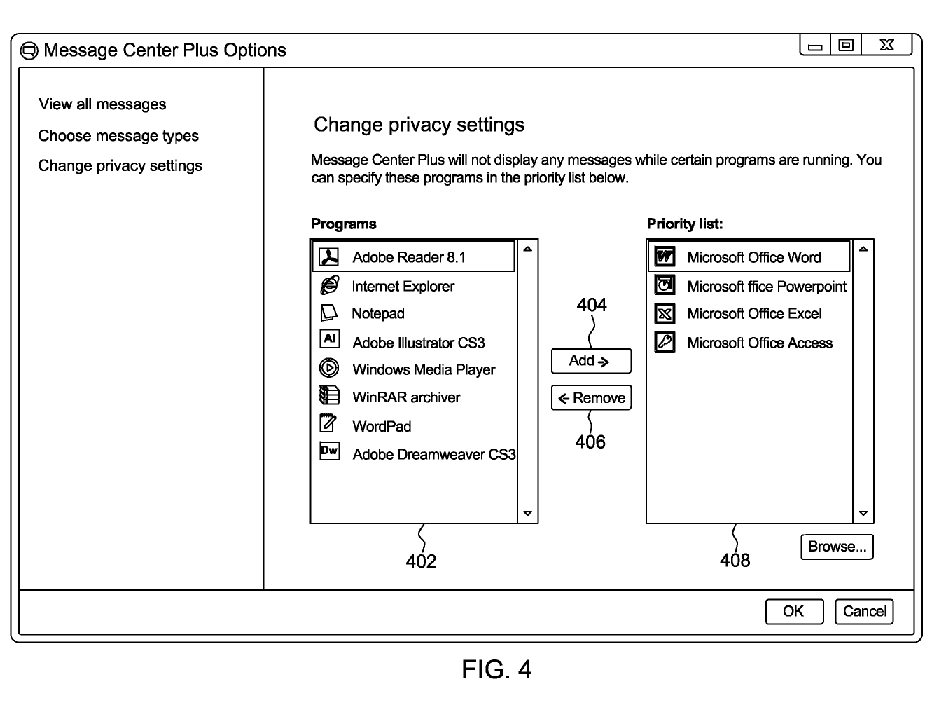

Referring to FIG. 4, a window which implements step 278 is illustrated. A complete list of application programs may be provided in window panel 402. The add and remove buttons 404 and 406, respectively, may be used to move selected application programs which are highlighted with a cursor, between window panels 402, and a priority list in window panel 408. When programs are moved to the priority list, messages will not be displayed when those programs are running. A check may be made by the software to ascertain which programs are running by examining a list of programs of the type generated by the operating system, such as in a task manager, which under a process tab, lists all programs that are currently running on computer system 12. If a program is in the list indicative of programs running, no messages will be displayed while that program is running.

In a similar manner, a window may be displayed, or a third window panel may be added to the display represented in FIG. 4, which causes a message to be displayed, when an application is running. This can be configured to override the selection made at steps 20 and 272 of FIG. 2A, so that, for example, selected emergency messages are shown, even during a presentation.

The disclosed embodiment may be implemented with appropriate software running on a computer system. It may also be implemented in hardware, including various types of circuitry, and in a combination of hardware and software. The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

It should be understood that the foregoing description is only illustrative. Various alternatives and modifications can be devised by those skilled in the art without departing from the invention. Accordingly, the present invention is intended to embrace all such alternatives, modifications and variances that fall within the scope of the appended claims.

What is claimed is:

1. A method comprising:
providing a presentation, on a display associated with an information handling system, a list of application programs installed on said system; and
receiving an indication as to whether or not messages are displayed, when selected ones of said application programs are running on said system.

2. The method of claim 1, further comprising displaying on said display of said system only those types of messages that are selected in response to receiving said indication.

3. The method of claim 2, further comprising providing a list of types of messages to be selected.

4. The method of claim 3, wherein each type on the list is associated with a selector, and the types of messages displayed are only those for which a selection is made with said selector.

5. The method of claim 1, further comprising preventing display of messages when the display of the system is in a mode selected from the group consisting of full screen mode and presentation mode.

6. The method of claim 1, further comprising providing a presentation on said display of said system for entering at least one or more of at least one time and at least one day when messages are to be displayed.

7. A medium readable by an information handling system, said medium having code thereon, so that said system:
provides a presentation, on a display associated with said system, a list of application programs installed on said system; and
receives an indication as to whether or not messages are displayed when selected ones of said application programs are running on said system.

8. The medium of claim 7, further comprising code for displaying on said display of said system only those types of messages that are selected in response to said indication.

9. The medium of claim 7, further comprising code for providing a list of types of messages to be selected.

10. The medium of claim 7, further comprising code for providing a selector for each type on the list, wherein the types of messages displayed are only those for which a selection is made with said selector.

11. The medium of claim 7, further comprising code, for preventing display of messages when the display of the system is in a mode selected from the group consisting of full screen mode and presentation mode.

12. The medium of claim 7, further comprising code for providing a presentation on said display of said system for entering at least one or more of at least one time and at least one day when messages are to be displayed.

13. An information handling system, comprising:
a processor;
a memory, said memory having processor instructions therein for use by the processor to cause said system to:
provide a presentation, on a display associated with said system, a list of application programs installed on said system; and
receive an indication as to whether or not messages are displayed, when selected ones of said application programs are running on said system.

14. The system of claim 13, wherein said instructions in said memory further comprise instructions for the processor to cause said system to display on said display of said system only those types of messages that are selected in response to said indication.

15. The system of claim 14, wherein said instructions in said memory further comprise instructions for the processor to cause said system to provide a list of types of messages to be selected.

16. The system of claim 14, wherein said instructions in said memory further comprise instructions for the processor to cause said system to provide a selector, and the types of messages displayed are only those for which a selection is made with said selector.

17. The system of claim 13, wherein said instructions in said memory further comprise instructions for the processor to cause said system to prevent display of messages when the display of the system is in a mode selected from the group consisting of full screen mode and presentation mode.

18. The system of claim 13, wherein said instructions in said memory further comprise instructions for the processor to cause said system to select at least one day and at least one time when messages are to be displayed.

19. A method for use in a digital device having a message display system for displaying various types of messages received from a network to which the device is connected, said message display system preventing display of messages when the display of the device is in a selected mode.

20. The method of claim 19, wherein the mode is selected from the group consisting of full screen mode and presentation mode.
